(19) United States
(12) Patent Application Publication
(10) Pub. No.: US 2024/0281263 A1
(43) Pub. Date: Aug. 22, 2024

(54) METHOD AND SYSTEM FOR MANAGING EDGE COMPUTING NODES VIA USER EQUIPMENT CROSS REFERENCE TO RELATED APPLICATIONS

(71) Applicant: UNIVERSIDAD DE VIGO, Vigo (ES)

(72) Inventors: Alberto Estévez Caldas, Vigo (ES); Rubén Pérez Vaz, Gondomar (ES); Francisco Javier González Castaño, Vigo (ES); Felipe José Gil Castiñeira, Vigo (ES)

(73) Assignee: UNIVERSIDAD DE VIGO, Vigo (ES)

(21) Appl. No.: 18/545,454

(22) Filed: Dec. 19, 2023

Related U.S. Application Data
(60) Provisional application No. 63/447,569, filed on Feb. 22, 2023.

(51) Int. Cl. G06F 9/445

(52) U.S. Cl. CPC G06F 9/44505

(57) ABSTRACT

A method for decentralized management of edge computing nodes, where the user equipment assumes direct control of the edge nodes through an integrated edge manager module, which has means for seamlessly onboarding edge applications onto edge computing nodes, eliminating the need for a central management entity in the network. The user equipment further includes a context storage module to store applications and support the migration of their context into another edge computing node. The edge manager module of the user equipment can request the application context data of edge applications running in an edge computing node, store context data, onboard the edge application configurations in other edge computing nodes, instantiate the edge applications, and configure the application context data into the destination edge computing node, even in scenarios without direct connectivity between edge nodes.

### CROSS REFERENCE TO RELATED APPLICATIONS

This application claims priority to co-pending U.S. Application, Ser. No. 63/447,569, filed on Feb. 22, 2023 which is hereby incorporated by reference for all purposes.

### BACKGROUND OF THE INVENTION

The present invention relates to the field of edge computing, a paradigm that aims to provide computing, storage and network resources at the edge of the networks, that is, the part of the network that is closer to the user terminals. An edge computing system includes a set of edge computing nodes that are devices that perform edge computing tasks in the vicinity of user equipment (UE). Such tasks include data processing and storage and the execution of applications at the edge of the network.

A UE typically identified with the UE acronym, is a mobile device with which a user can access different types of resources via a mobile cellular network or similar communications network, for example a 3rd Generation Partnership Project (3GPP) network. UEs include a variety of different devices, such as smartphones, tablets and laptops.

Offloading intensive computation tasks or services to edge computing nodes simplifies the processing hardware of the UEs. Furthermore, thanks to physical proximity, a low latency between UEs and the applications executed at edge computing nodes can be ensured, thus meeting the requirements imposed by ultra-low latency use cases in mobile cellular networks.

In the case of mobile cellular networks such as 3GPP networks, UEs set connections to edge computing nodes via radio links to base stations. The latter are typically interconnected with edge computing nodes via wired networks. Several edge computing nodes can be internetworked with the same base station; an edge computing node can be an integral part of a base station, and any combination of these elements in a networking architecture is possible. A UE can set connections to multiple base stations via radio links, belonging to the same or different operators, and, through these, to multiple edge computing nodes, belonging to the same or different edge computing providers.

Edge computing architectures have been standardized within the Multi-Access Edge Computing (MEC) framework by the European Telecommunication Standards Institute (ETSI) and by the 3GPP in the EdgeApp architecture. The MEC edge computing architecture is divided into three different entities: system level, host level and network level. End users can access edge computing services in edge computing nodes using different access network technologies, such as Wi-Fi, fixed networks or 3GPP 4G and 5G networks. However, the 3GPP EdgeApp system has standardized an application layer architecture that only allows accessing edge applications over 3GPP networks.

The ETSI MEC and EdgeApp architectures have limitations. A main limitation in both architectures is the need for a central management entity for each edge computing system. In the case of the ETSI MEC, that entity is the MEC orchestrator, and in the case of EdgeApp, the Edge Management. Both management entities handle multiple management decisions, such as onboarding of new applications and instantiating applications at computing nodes. Such central management entities can compromise scalability and security, as they are single points of control and failure for the entire system.

Another main limitation of these architectures arises when they are deployed in 3GPP networks. Users of these networks exhibit a nomadic behavior, roaming between base station cells and connecting to multiple 3GPP networks during roaming. In this scenario, users may lose coverage from the previous network operator and edge computing system they are attached to. Therefore, it may be necessary to coordinate and manage multiple independent edge computing nodes, which may belong to the same edge computing system or not, to guarantee optimal performance and low latency between the UEs and the edge applications.

Several efforts have been carried out by the Global System for Mobile communication (GSMA) to facilitate the management and exchange of information between edge computing nodes that may belong to multiple independent edge computing systems. The GSMA, in its “Operator Platform Telco Edge Requirements v.2.0” whitepaper published on Apr. 1, 2022, proposes a platform to enable the centralized management and orchestration of multiple edge computing systems in 3GPP networks. As in the cases of the ETSI MEC orchestrator and the Edge Management of EdgeApp, the GSMA Operator Platform solution relies on an architecture with a single point of control and failure for the superset of edge computing systems integrated within the Operator Platform. In addition, the Operator Platform architecture implies the necessity to have connectivity with the platform in each edge computing node. This is cumbersome when operators need to deploy stand-alone edge computing systems (without external connections) that only provide edge computing services to UEs nearby, for example in remote areas, emergency situations, tactical networks, etc.

Over the last few years, edge computing has emerged as a disruptive technology for next-generation networks. Diverse related patents, focusing on technical solutions and application use cases of edge computing, have been granted.

Patent US 2014/0287754 A1 proposes a femtocloud architecture for a group of base stations to support applications running in UEs. This femtocloud architecture is controlled by a network-side femtocloud control program. A UE may request offloading one application to one or more base stations, and in the event of a handover to another base station, the femtocloud control program will be in charge of transferring the execution of the application among different nodes. However, this patent does not cover scenarios in which the computing nodes associated to the base stations are not controlled by a centralized entity such as the femtocloud control program, nor scenarios in which the base stations do not belong to the same cellular communications network, nor is compatible with scenarios with stand-alone base stations without a common backhaul, unlike the present invention.

Patent U.S. Pat. No. 11,258,873 B2 proposes an entire edge computing architecture and framework for mobility scenarios. This architecture is part of the ETSI MEC architecture. However, as previously described for the case of ETSI MEC, this invention requires a central management entity, the MEC orchestrator, which can control the overall state of the network. This, as previously said, can compromise security, scalability, and performance.

Patent US 2016/0095041 A1 proposes a system that allows application context migration between edge computing nodes in mobile environments. This invention proposes the use of EdgeApp State Inspection and Replay Server (ESIRS) components connected to the edge computing nodes, in charge of transferring application contexts from the source edge computing node to the destination edge computing node. However, this context migration must be performed over a network backhaul, and the ESIRS component must be able to reach both edge computing nodes involved.

Patent U.S. Pat. No. 9,591,085 B2 proposes a method for seamless migration of network communication sessions between a client device and a first server to communication sessions between the client device and a second server. In the specific context of cellular networks, the patent refers to a mobile client device and a plurality of edge servers and a method for maintaining network communications sessions between mobile devices and edge computing nodes when a device is moving across the network, as well as setting a connection between the device and a new edge computing node. It does not consider stateful edge applications at edge computing nodes nor the migration of context data of an edge application between nodes, since context data is always stored in the mobile device and the edge application only performs computational tasks.

Patent U.S. Pat. No. 10,813,010 B2 proposes a method to implement an edge computing handover service element to store information of an application for an end device. One of the responsibilities of this element during a handover procedure is to assess whether it is necessary to provision the new edge computing network with the application information and, if so, carry out the provisioning procedure. It does not consider the migration of application information through the mobile terminal, as it is managed by the edge computing handover service element. The edge computing handover service element stores the application information at a point within the mobile network, but not on end devices themselves, and provisions the target edge computing network with the necessary application, service, content, and context information based on mobility information.

### SUMMARY OF THE INVENTION

The present invention relates to an original method and system for managing multiple edge computing nodes directly controlled by UE devices. It involves two types of devices: UE devices capable of executing tasks with low computational demands that also need to offload more computationally intensive tasks, and edge computing nodes responsible for executing these computationally intensive tasks.

This invention encompasses techniques for UE devices to directly configure information for instantiating edge applications on the edge computing nodes (onboarding), to upload edge application images to computing nodes (provided that application images are not available at the computing node or elsewhere), and to manage the lifecycle of their own edge applications, such as instantiation, updating, termination, and deletion in the target edge computing nodes.

This invention also includes methods for UE devices to orchestrate the migration of edge applications' context data between edge computing nodes. In one embodiment, UE devices temporarily store the information of an edge application running at one edge computing node to transfer it to another edge computing node, while in another embodiment UE devices set a direct communication between edge computing nodes to directly transfer the information of an edge application from one edge computing node to another.

Several advantages of one or more aspects of this invention are as follows: UE devices directly managing multiple edge computing systems, eliminating the need for a central management entity or simplifying it and allowing UE devices to directly manage their applications and their configurations in the edge computing nodes available; onboarding edge application configuration and uploading edge application images from UE devices to multiple edge computing nodes, eliminating the requirement of a centralized provisioner of edge application images and its configuration; and migrating application context data of the edge applications from one edge computing node to another, using the UE to locally store that application context data or establishing a direct communication link between edge computing nodes via the UE, where both edge computing nodes may belong to edge computing systems of the same operator or not, hence not requiring direct connectivity between these edge computing nodes. Other advantages of one or more aspects will be apparent from a consideration of the drawings and ensuing description.

### BRIEF DESCRIPTION OF DRAWINGS

To complete the description and in order to provide a better understanding of the invention, a set of drawings is provided. Said drawings form an integral part of the description and illustrate a preferred embodiment of the invention, which should not be interpreted as restricting the scope of the invention, but rather as an example of how the invention can be carried out. The components in the drawings are not necessarily to scale relative to each other.

FIG. 1 illustrates a diagram representing the main blocks of the invention. It includes the two elements involved in it, the UE and the edge computing node, as well as the way they interact.

FIG. 2 illustrates the components involved in an edge data network and the connection between the network's base station and a UE. The edge data network consists of a base station and one or more edge computing nodes, and the UE is responsible for performing onboarding of application configurations, uploading application images, and managing the application lifecycle operations in these edge computing nodes.

FIG. 3 illustrates the components involved in an application handover procedure performed in a scenario in which it is not possible to simultaneously establish a connection with two different base stations. This scenario includes the instantiation of the application in the new edge computing node.

FIG. 4 illustrates the components involved in an application handover procedure in a scenario in which the UE can establish a connection with two base stations at the same time. This scenario includes the instantiation of the application in the new edge computing node.

FIG. 5 illustrates a sequence diagram for FIG. 2 and the necessary steps that the UE takes for application configuration onboarding, application image uploading and lifecycle management of an edge application at an edge computing node.

FIG. 6 illustrates a sequence diagram for FIG. 3 and depicts the steps taken by the UE for directly managing edge computing nodes. It shows the application context relocation procedure between edge computing nodes, applicable in scenarios in which the UE has the capability to store the application context in a local module.

FIG. 7 illustrates a sequence diagram for FIG. 4 and depicts the steps taken by the UE for directly managing edge computing nodes. It shows a scenario in which the UE has the capability to simultaneously keep connections with two base stations and where the migration is directly performed from one edge computing node to another via secure connections established between the UE and the edge computing nodes.

### DETAILED DESCRIPTION OF THE INVENTION

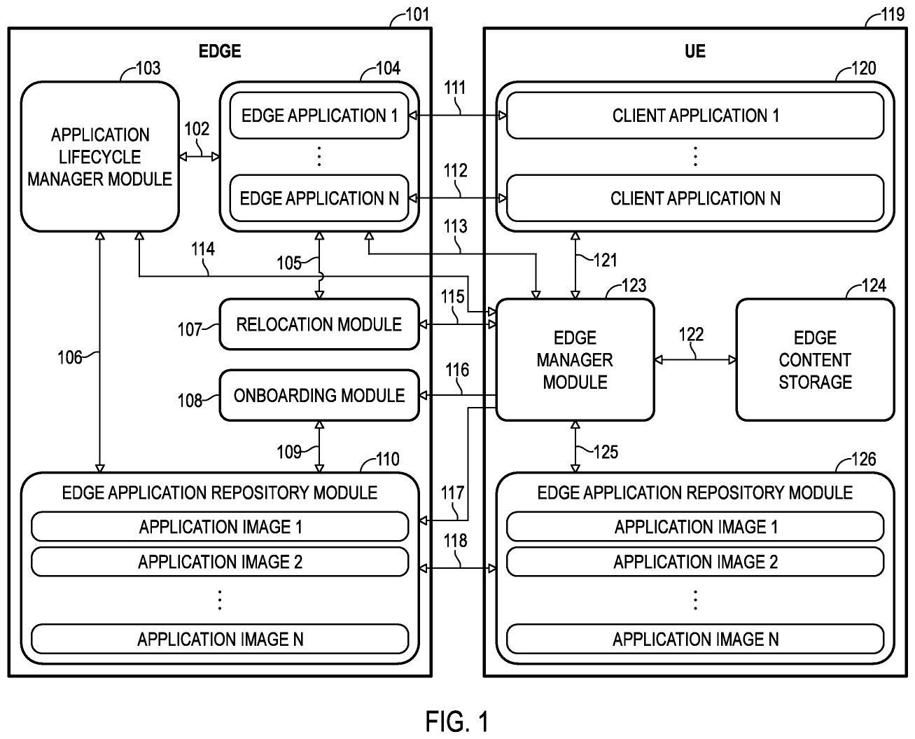

The present invention is related to various configurations for implementing a method for managing edge computing nodes from a UE, as depicted in FIGS. 1, 2, 3, 4, 5, 6 and 7 of this patent application. These embodiments illustrate various approaches for carrying out the necessary operations for managing edge computing nodes through the UE, including but not limited to, initiating application procedures, managing the lifecycle of the edge applications, and implementing potential solutions for migrating the application and its context from one edge computing node to another. The present invention also encompasses the ability to establish secure communications between edge computing nodes through the UE, as well as the capability to store and transfer data from one edge computing node to another.

It is important to note that the specific configuration and method illustrated in the figures of this patent application are provided for illustrative purposes only and should not be considered as limiting the scope of the present invention. The present invention encompasses a wide range of configurations and methods for implementing the management of edge computing nodes from UE devices, and it is not restricted to the specific examples provided in this patent application.

The disclosed examples of the various embodiments described herein can be varied, modified, and altered to suit different applications and design considerations. Through review of the detailed description and figures, those skilled in the art will understand how the various embodiments of the inventions can be implemented. However, for the sake of brevity, not every contemplated variation is individually described in the following detailed description.

Throughout the detailed description, a variety of example embodiments are provided that may include identical, similar, or dissimilar related features. In order to avoid redundancy, related features are not explained in each example. Instead, the use of related feature names serves to indicate that the feature in question may be similar to a related feature described in a previous example. Features that are specific to a particular example will be described in that example. It should be understood that a given feature may not necessarily be the same or similar to the specific version of a related feature in any given figure or example.

FIG. 1 illustrates a block diagram of the present invention. Element 101 represents an edge computing node, while element 119 represents the UE that is served by the edge computing node. At the edge computing node side, element 103 represents the application lifecycle manager for the applications running on the node. This element is responsible for tasks such as the instantiation of the edge applications (104) through connection 102. Element 103 is also responsible for retrieving the application images from the edge application repository 110 using connection 106. Alongside the previously described elements, onboarding module 108 is provided to set up the configuration of edge applications in the edge computing node. Additionally, the relocation module 107 is provided to enable communication and context relocation capabilities between the edge computing node and the edge manager 123 in the UE via connection 115. This component also sets the context in the applications running using connection 105.

At the UE side (119), edge manager module 123 acts as the core element, which carries out the necessary operations for managing edge computing nodes, including, but not limited to, onboarding applications, commanding the uploading of edge application images, managing the lifecycle of the edge applications, and implementing solutions for migrating the application and its context from one edge computing node to another through UE. Element 126 is an edge application repository module to store edge application images. This module can directly transfer application images to edge application repositories (110) on the edge computing node (102) using connection 118 as well as communicate with the edge manager module 123 using connection 125. Element 124 is an edge context storage to temporarily save context information during edge application migration procedures, as commanded by the edge manager module 123. Finally, client applications (120) are connected to the workloads executed as edge applications (104) on the edge computing node (102) using connections such as 111 and 112.

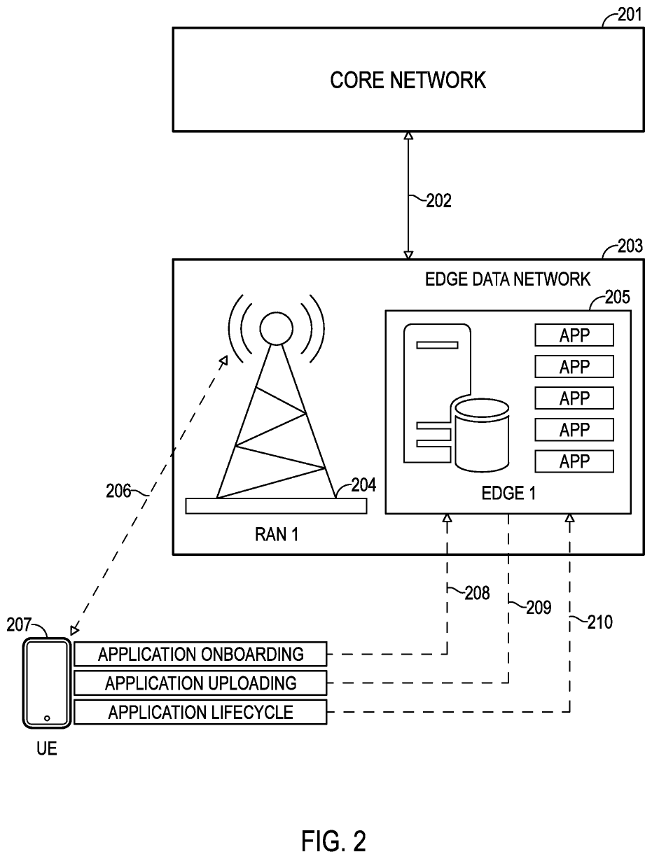

FIG. 2 illustrates an embodiment for implementing the procedures for onboarding applications' configurations, uploading edge application images and managing the lifecycle of edge applications via a UE device, as protected by the claims of this patent application.

Element 201 represents a mobile network core that is similar in structure to those found in 3GPP networks. It is important to recognize that the inclusion of a mobile network core with this design, as described in the specification, is only one example and is not a mandatory feature of the claimed invention. The invention can be implemented using mobile network cores of different designs and is not restricted to the particular example provided in the specification.

Element 203 depicts the edge data network, comprising element 204, which embodies a base station of a radio access network communication system, and element 205, which embodies an edge computing node. The edge data network (203) is connected to the mobile network core (201) via connection link 202. It should be noted that the inclusion of a radio access network is provided as an example and is not a necessary aspect of the invention. The invention may be implemented using other types of access networks or devices to establish communication links between the core network and the end devices and the edge computing nodes.

Element 207 represents a UE with radio functionality, such as a UE in a 3GPP network. It is important to note that the inclusion of a 3GPP UE is provided as one example and is not a necessary element of the invention. The UE represented by element 207 may be any type of wireless device that is able to establish a link with base station 204 via radio link 206, and is not restricted to the specific example provided in the specification. Elements 207, 208 and 209 depict the onboarding, uploading and lifecycle operations of an application, executed by the UE (207) on the edge computing node (205). Direct connections 208, 209 and 210 between UE (207) and edge computing node (205) are depicted for illustrative purposes of the onboarding, uploading and lifecycle procedures only, as the physical connection is achieved through element 206.

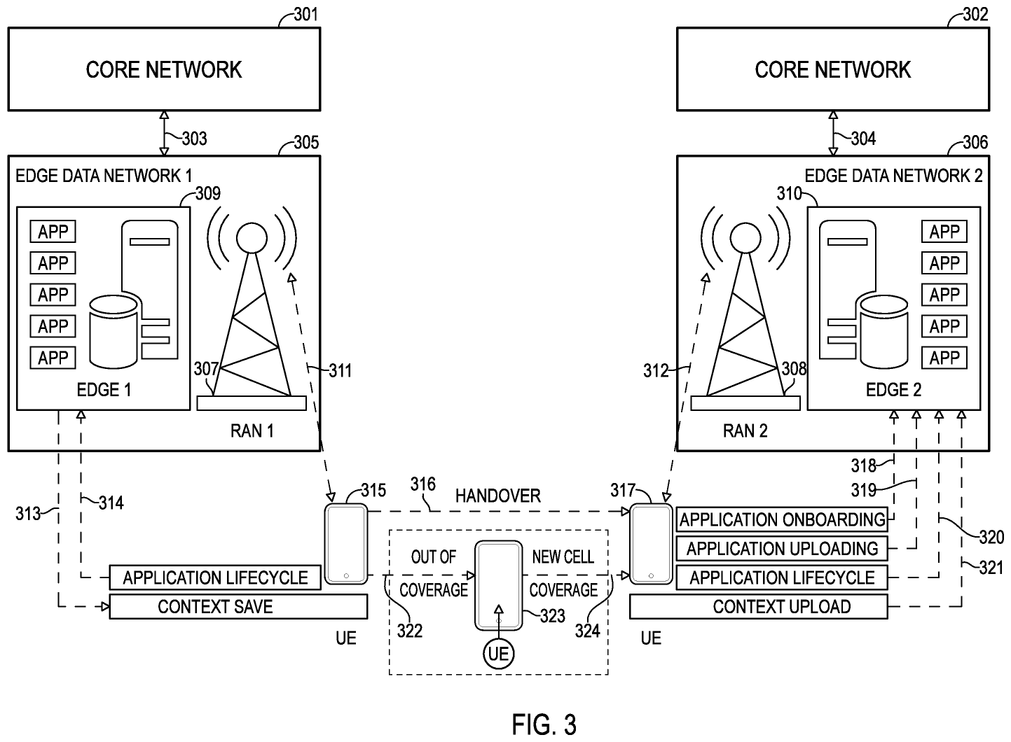

FIG. 3 illustrates an embodiment for implementing the procedure for transferring application context data from one edge computing node to another via a UE device. In this embodiment, it is assumed that the UE has the ability to retrieve, store and transfer application context data between edge computing nodes, as protected by the claims of this patent application.

Elements 301 and 302 represent two core networks (for example, two 3GPP core networks). Core network elements 301 and 302 are connected with the edge data networks elements 305 and 306 using links 303 and 304, respectively. Elements 307 and 308 represent the edge computing nodes located in the geographical area of edge data networks 305 and 306. In this embodiment, core data network 301 does not have connectivity with core data network 302 and edge data network 305 does not have connectivity with edge data network 306.

Edge data networks 305 and 306 are composed of base stations elements 307 and 308, and edge computing nodes 309 and 310, respectively, so that these edge data networks offer edge computing capabilities for UE devices to offload computational tasks or services.

Element 315 represents a UE device at its initial position. This UE may be any type of wireless device that can establish a radio link 311 with base station 307. In this embodiment, it is assumed that the UE has already performed the onboarding of its edge application configuration and has already uploaded the necessary edge application images to edge computing node 309, following the procedures indicated in the embodiment of FIG. 2. Also, it is assumed that one or more edge applications are running and serving UE 315 in edge computing node 309. As UE 315 moves, it can reach an area with poor coverage from base station 307. A trigger at the UE (315) side will start a procedure to retrieve and store the context data in the UE (313). Additionally, the UE may locally store the context data on a periodical basis. Besides, the UE is responsible for deleting the application, by performing application lifecycle operations, on the edge computing node (309) once the context has been saved in the UE using connection 314.

The UE may move to a location out of coverage of base station 307 (322). At this moment, the UE (323) already has the application context saved in its local edge context storage 124. UE 323 can directly execute the application when out of coverage. Once UE 323 moves into the coverage area of base station 308, it establishes a new connection to that base station (312). Then, UE (317) starts the onboarding of application configuration 318 on the edge computing node(310). Once this configuration has been fully onboarded, the UE commands, if necessary, the uploading of the edge application image to the edge computing node (319). Additionally, the UE requests the instantiation of the edge application by triggering the corresponding application lifecycle operation (320). Once the application is instantiated in the new edge computing node (310), UE 317 uploads the application context (321). It should be noted that the loss of coverage is not a necessary condition of the claims of this invention, and it is only provided as an example, other situations such as having another base station with higher signal level or capabilities within UE reach may also apply to this same embodiment.

Direct connections 313, 314, 318, 319, 320 and 321 between UE 317 and edge computing nodes 309 and 310 are depicted for illustrative purposes of the application onboarding, application uploading, application lifecycle, context save and context upload procedures only, as the physical connection is achieved through elements 311 and 312.

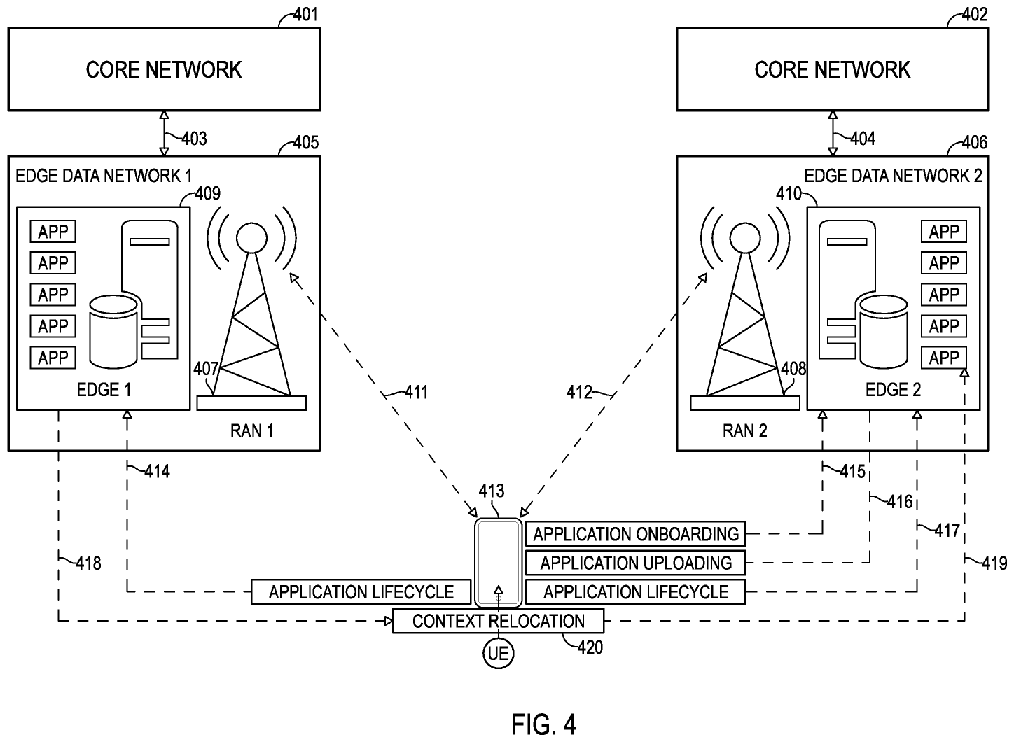

FIG. 4 illustrates an embodiment for implementing the procedure to establish secure connections between edge computing nodes via the UE. In this embodiment, the secure connections between the edge computing nodes are used to directly transfer application context data from one edge computing node to another, as protected by the claims of this patent application.

Core networks 401 and 402 correspond to 301 and 302 respectively. Similarly, edge data networks 405 and 406 correspond to 305 and 306. Core networks 401 and 402 are connected to edge data networks 405 and 406 through links 403 and 404, respectively.

Elements 407 and 408 represent the radio access network resources of two different base stations, respectively connected with the core networks by links 403 and 404. It should be noted that the inclusion of a radio access network is provided as an example and is not a necessary aspect of the invention. The invention may be implemented using other types of access networks or devices to establish communication links between the core network and end devices and the edge computing nodes. The technology utilized for these data links, whether aerial or wired (e.g. optical fiber), is not specified in this embodiment. Elements 409 and 410 represent the edge computing nodes located in the same geographical area of edge data networks 405 and 406.

Element 413 represents a UE device equipped with radio capabilities. The UE represented by element 413 may be any type of wireless device that is capable of establishing a radio link with radio access networks 407 and 408 and is not limited to the specific example described in the text. This embodiment assumes that the UE has the capability to concurrently connect and keep links with both radio access networks 407 and 408, for example as specified in 3GPP 5G Release 15 and any subsequent releases. The invention may be implemented using other methods or techniques for implementing concurrent connectivity, and is not limited to the specific implementation described in 3GPP 5G Release 15. The links with radio access elements 407 and 408 are depicted in the figure as links 411 and 412.

Using links 411 and 412, UE 413 can establish connections with edge computing nodes 409 and 410 respectively. These connections allow element 413 to onboard edge application configurations, upload edge application images and manage the lifecycles of edge applications at edge computing nodes 409 and 410 (415, 416 and 417). Communications links 411 and 412 are also used by UE 413 to establish an end-to-end communication link between edge computing nodes 409 and 410 (420). This end-to-end communications link allows for the direct exchange of data, such as application context information, between edge computing nodes. It should be noted that the exchange of application context information mentioned in this text is provided only as an example and is not a necessary aspect of the invention. End-to-end communication link 420 may be used to exchange any type of data, and the invention is not limited to the specific example described in the text.

Direct connections 414, 415, 416, 417, 418 and 419 between UE 413 and edge computing nodes 409 and 410 are depicted for illustrative purposes of the application onboarding, application uploading, application lifecycle, context save and context upload procedures only, as the physical connection is achieved through elements 411 and 412.

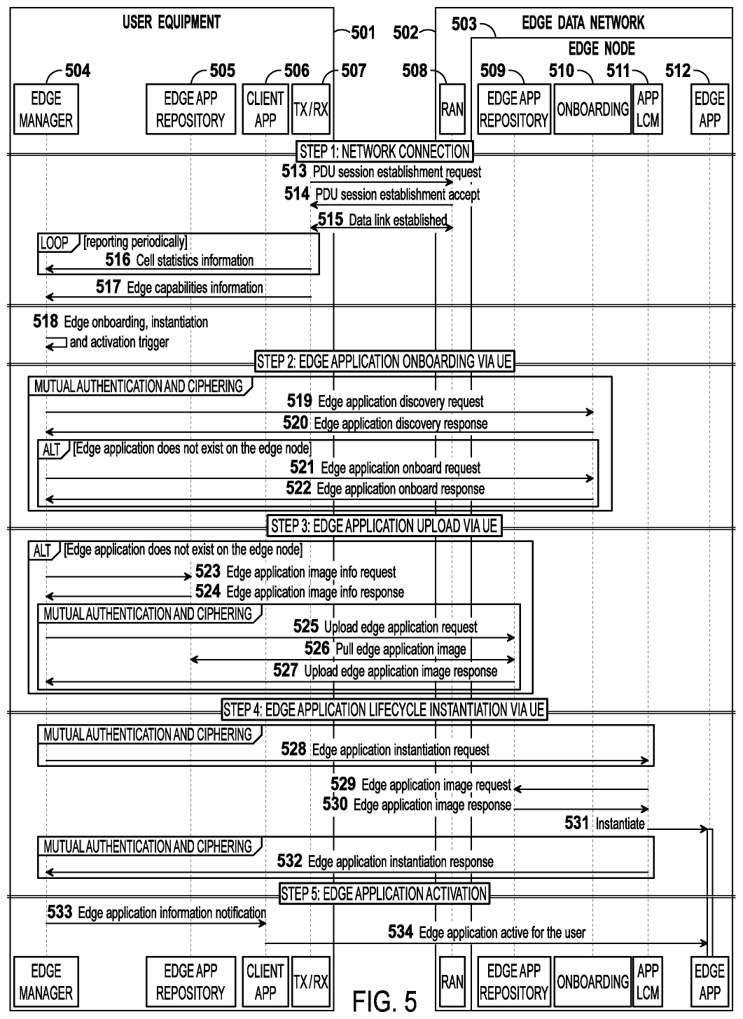

FIG. 5 depicts a method for implementing the system proposed in FIG. 2. This embodiment is composed of two main elements: a UE, represented by element 501, and an edge data network, represented by element 502 including an edge computing node 503. It is assumed that the UE has the capability to establish a Protocol Data Unit (PDU) session with a core network (for example, a 3GPP core network or a similar communication architecture). It should be understood that the specific method illustrated in this embodiment is provided for illustrative purposes only and should not be considered as limiting the scope of the present invention.

At the edge data network side (502), a base station element (508) is included to provide wireless connectivity to the UE devices. The onboarding procedure on the edge computing node (503) involves three elements. Firstly, edge application repository module 509 is in charge of receiving, storing and providing to the rest of the modules new edge application images received from UE devices. Secondly, onboarding module 510 can configure the requested features for the application in the edge computing node. Thirdly, application lifecycle management module (APP LCM) 511 is responsible for the instantiation, termination, and deletion of applications on the edge computing nodes. Lastly, the resources for executing applications in the edge computing nodes are represented by element 511.

At the UE side (501) there are other modules involved in the onboarding procedure. The edge manager 504 is responsible for coordinating and managing the operations performed on the edge computing nodes. Edge application repository 505 can store and provide access capabilities to the application images that will be used. Client application 506 is the module that provides to the UE devices the functionality of the applications that run on the edge computing nodes. Finally, UE radio module 507 provides wireless communication capabilities and enables the communication between the UE and edge data network 502.

The first step of the sequence chart in FIG. 5 starts with the connection to a cellular network. This means that UE 501 sets a new connection to the cellular communications network or a similar network. Under this assumption, elements 513 and 514 represent the PDU session establishment request and response messages. After this, element 515 represents the connection that is established between UE 501 and edge data network 502. Radio module 507 can provide measurements about the cell as shown in message 517. Moreover, radio module 507 may also send information about the edge capabilities of the base station to the edge manager 504 (517). This information may trigger the initiation of an onboarding procedure (518).

The second step of the message sequence describes the onboarding procedure from the UE. This procedure starts with a discovery procedure by edge manager 504 issued to the edge application repository on the edge computing node (509), to obtain information about the availability of the application in the edge computing node. These communications are represented by messages 519 and 520. With the information returned in message 520, edge manager 504 can determine if the application configuration already exists in the edge computing node. Otherwise, it can perform the onboarding, as shown in messages 521 and 522.

The third step of the embodiment sequence is the application upload from the UE. In this step, edge manager 504 requests the application image to edge application repository 505, as shown in messages 523 and 524. After this, edge manager 504 will command to edge application repository 509 the pulling process from the edge application repository on UE 505, as shown in messages 525, 526 and 527.

The fourth step of the sequence is the application instantiation that is initiated by the UE. At this point, the application image is already available at the edge computing node (503), and it is ready to be instantiated. Edge manager 504 will send an instantiation request to APP LCM 511 on the edge computing node as shown in message 528. The APP LCM module will request to the application repository (509) the application image, as shown in messages 529 and 530. Finally, APP LCM 511 will instantiate application 512 as shown in message 531. After this instantiation is completed, APP LCM 511 will notify edge manager 504 about the result of the instantiation (532).

The last step of this embodiment is the activation of the application, in which edge manager 504 notifies the client application 506 in the UE that the application is available in the new location. The client application shall reconfigure all the parameters to allow the connection with the executed application (533).

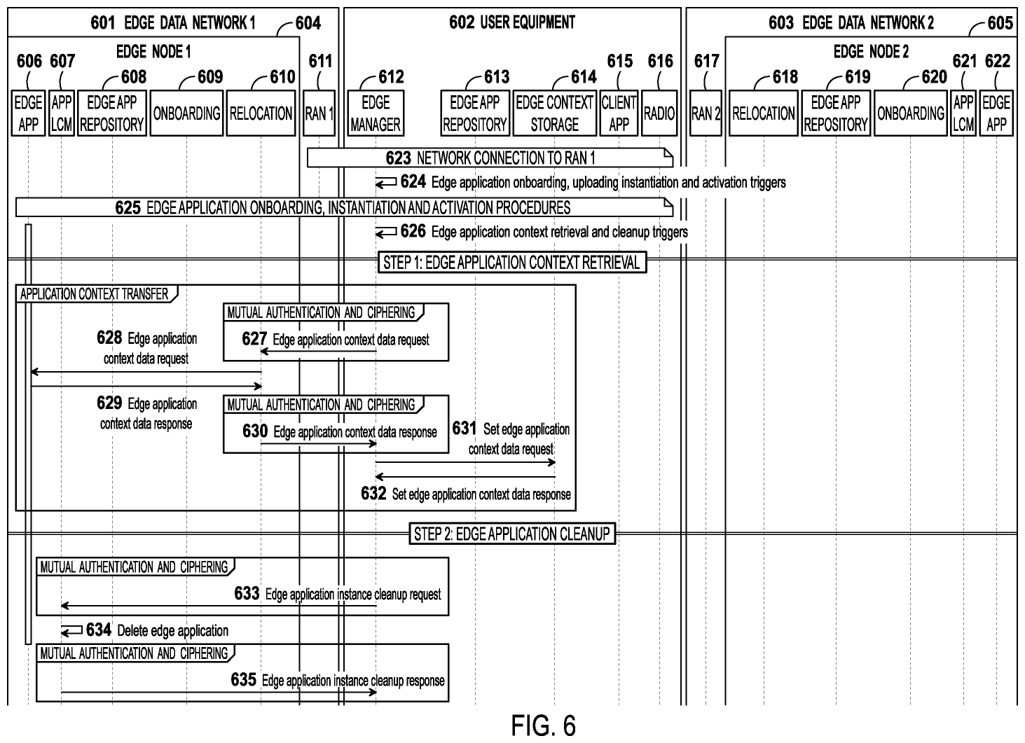

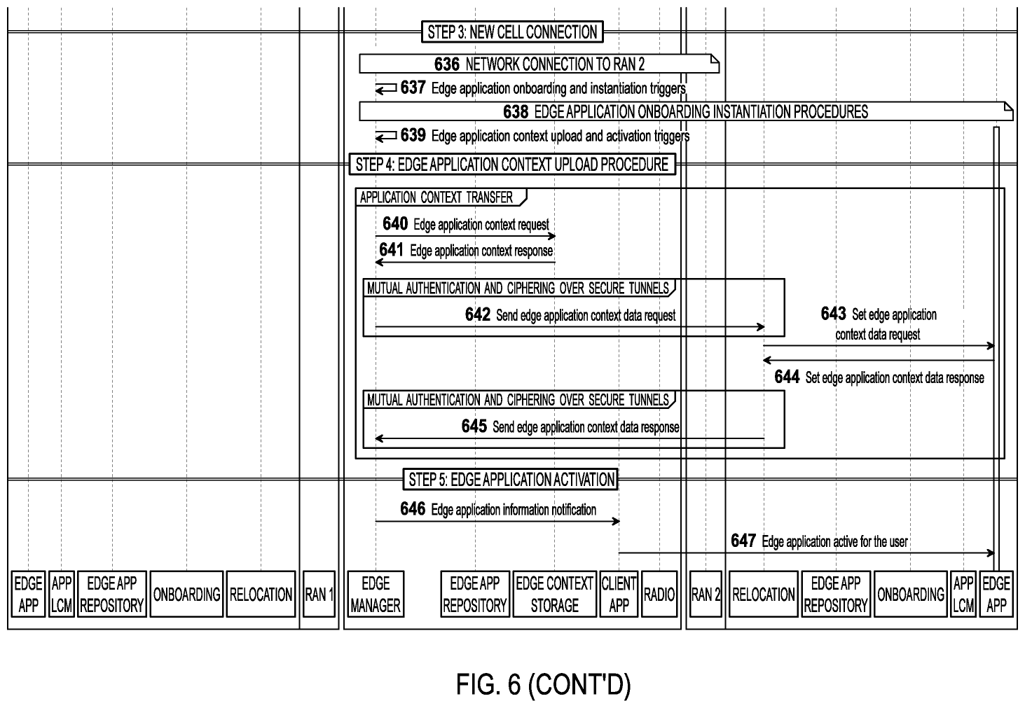

FIG. 6 depicts a method for implementing the system proposed in FIG. 3. This embodiment illustrates various steps to implement the necessary operations for managing edge computing nodes, including, but not limited to, initiating application procedures through the UE, managing the lifecycle of the edge applications, and a solution for migrating context data of an edge application from one edge computing node to another through the UE. It should be understood that the specific configuration and method illustrated in this embodiment is provided for illustrative purposes only and should not be considered as limiting the scope of the present invention.

This embodiment is composed of three main elements: an edge data network represented by element 601 including an edge computing node (604), a UE 602, and another edge data network with an edge computing node, represented by elements 603 and 605 respectively. It is assumed that UE 602 has the capability to establish a Protocol Data Unit (PDU) session with a core network (for example, a 3GPP core network or a similar communication architecture). Also, it is assumed that it has the capability to store and upload edge applications images to edge computing nodes and to retrieve, store and upload application context data of edge applications from one edge computing node to another.

Elements 606 and 622 represent edge applications instances that provide resources and services to client application 615. Application lifecycle managers 607 and 621 are responsible for lifecycle operations of edge applications at the respective edge computing nodes. Elements 609 and 620 allow the onboarding of configuration information of edge applications in the edge computing nodes, while edge application repository modules 608 and 619 can store edge applications images from various sources. This embodiment only shows the case when the edge application image is directly uploaded from UE 602. Relocation modules 610 and 618 are responsible for managing the context data of an edge application at edge computing nodes.

Edge manager module 612, as previously described, is in charge of orchestrating edge operations, such as onboarding, images' uploading, lifecycles of edge applications, and edge applications' context data migrations. Element 616 is used to establish a radio link with edge data networks 604 and 605, using wireless or similar communications systems. Edge application repository 613 allows edge manager 612 to upload edge application images to an edge Computing node.

In this embodiment, it is assumed that client application 615 running on UE 602 needs to offload computational tasks to an edge application. Also, it is assumed that the UE includes edge context storage 614 to store the application context during the edge application migration.

It should be noted that initial steps 623, 624, and 625, as depicted in FIG. 6, are directly related to the sequence procedure outlined in FIG. 5 and are included in this embodiment for the purpose of providing a comprehensive understanding of the overall process. However, for the sake of brevity and clarity, the details of these steps will not be further described.

After the edge application is instantiated, the context retrieval procedure begins as part of a context retrieval trigger in edge manager 612 (626). At this point, edge manager 612 determines that it is necessary to initiate the context retrieval operation to temporarily store the edge application context data in edge context storage 614 and remove the edge application from edge computing node 604. This decision may be taken as a result of detecting that the UE is moving to an area without coverage, as depicted by element 322 in FIG. 3, or detecting a new cell with improved coverage and deciding to initiate the handover procedure, as illustrated by element 316 in FIG. 3. This embodiment shows one possible solution to retrieve the application context data from edge application instances and store them in edge context storage 614 as follows.

Edge manager 612 sends message 627 over a secure channel, where both sides must authenticate and encrypt the communication using a method such as the mutual transport layer security (mTLS) protocol, to relocation module 610, indicating that it is necessary to migrate the edge application instance 606. In response, relocation module 610 initiates the retrieval of edge application context data by sending message 628. Edge application context data are obtained through message 629. Relocation module 610 subsequently sends over a secure channel the obtained context data to edge manager 612 using message 630. Edge manager 612 stores the received context data in its edge context storage, as depicted by messages 631 and 632.

The next step in the sequence diagram, as depicted in FIG. 6, refers to the cleanup procedure, which refers to the removal of the edge application instance 606 from the current edge computing node 604. This process is initiated by message 633, sent by edge manager 612 to application lifecycle manager 607 over a secure channel. Upon receipt of this message, APP LCM 607 deletes edge application instance 606 from edge computing node 604 to free up storage and resources for other processes. Confirmation message 635 is sent by APP LCM 607 to edge manager 612 over a secure channel, indicating the successful elimination of edge application 606.

Upon completion of the cleanup procedure, the next step at the UE side is setting a connection to new base station 617, either directly through a handover procedure or by first experiencing an outage without any available base stations to connect to. Similarly to message 623, message 636 refers to the process of establishing a PDU Session procedure with edge data network 603. Edge manager 612 subsequently triggers message 637, initiating the onboarding and instantiation of the edge application in edge computing node 605 (638). Edge manager 612 is aware that it is necessary not only to onboard, instantiate and activate the edge application, but also to set the application context data for the new edge application instance 622. Therefore, edge manager 612 initiates the procedure for uploading the application context data to edge application 622 on edge computing node 605 as follows:

The process begins with edge manager 612 requesting, through message 640, the stored application context data to local edge context storage 614. Edge manager 612 subsequently receives the application context data in message 641 and sends it to relocation module 618 over a secure channel using message 642. Upon receipt of the application context data from the UE, relocation module 618 configures edge application 622 using messages 643 and 644 with the received application context data. Relocation module 618 subsequently sends the result of the application context data operation in message 645 to edge manager 612 over a secure channel.

The final step refers to the procedure for informing client application 615 about the new edge application that is available at edge computing node 605. Upon receipt of message 646, client application 615 updates its path to be served by edge application 622, thus completing the migration of the edge application and its associated context data from the previous edge computing node to the new one.

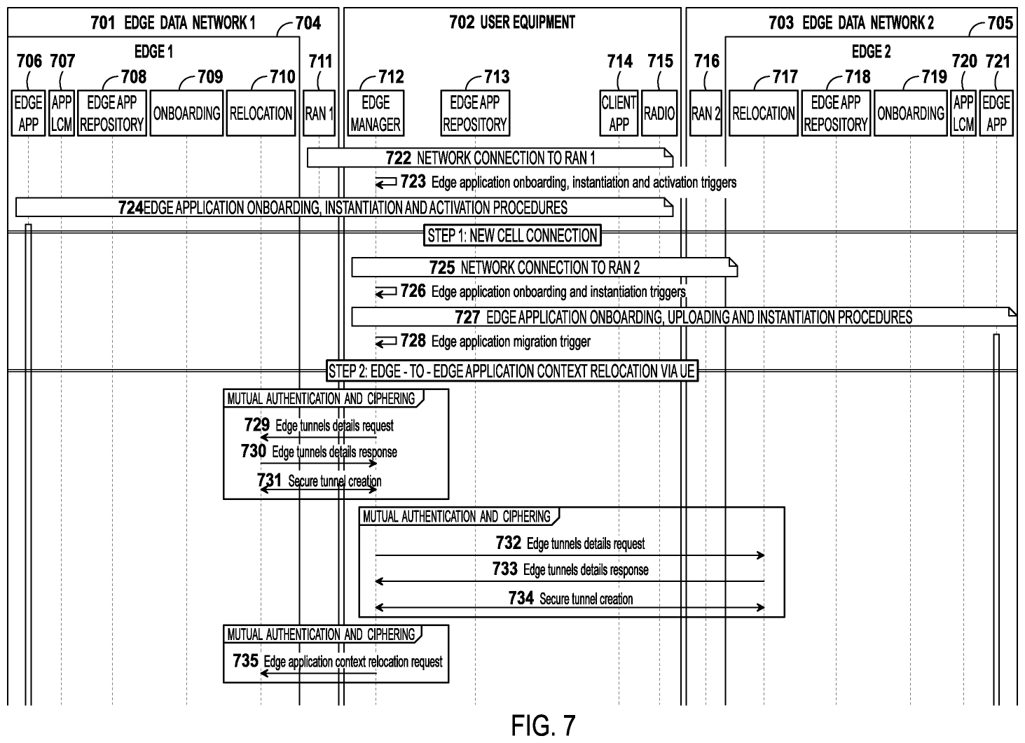

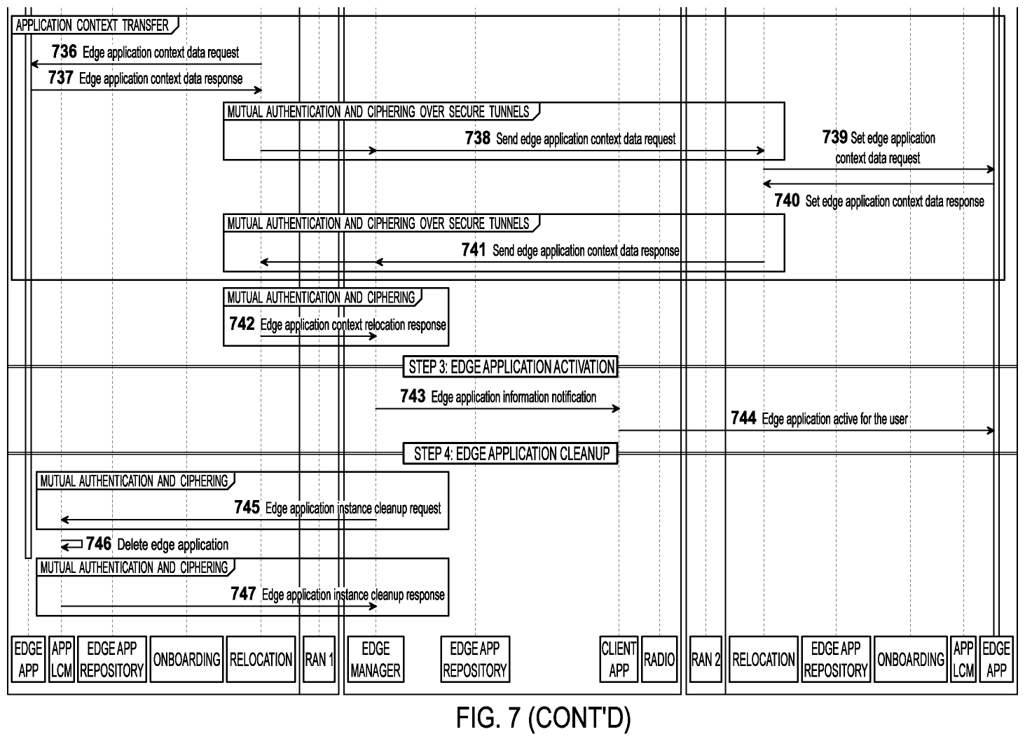

FIG. 7 illustrates another possible embodiment for managing edge computing nodes from UE. In this case, the embodiment is based on FIG. 4, and includes various steps for carrying out the necessary operations for managing edge computing nodes.

It should be noted that initial steps 722, 723, and 724, as depicted in FIG. 7, are directly related to the sequence procedure outlined in FIG. 5 and are included in this embodiment for the purpose of providing a comprehensive understanding of the overall process. However, for the sake of brevity and clarity, the details of these steps will not be further described within this embodiment.

The embodiment commences with edge manager 712 receiving a handover notification, initiating the process of establishing a new communication link 725 to edge data network 703, while concurrently maintaining the communication link with the previous edge data network 701.

Once the UE establishes connection 725 with edge data network 703 via radio access network 716, edge manager 712 decides that it is necessary to relocate the edge services to edge computing node 705. Therefore, edge manager 712 triggers action 726, initiating the onboarding and instantiation procedures (727) for edge computing node 705. For the sake of brevity and clarity, the details of step 727 will not be further described within this embodiment. Once procedure 727 finishes, edge manager 712 triggers action 728 to initiate the application context data relocation procedure as follows.

The first step is setting a secure tunnel between edge manager 712 and relocation modules 710 and 717. The secure tunnels are established over a secure channel, where both sides must authenticate themselves and cipher the communications, using a method such as the mTLS protocol. Edge manager 712 uses messages 729 to 734 to obtain the information needed to set up the tunnel between edge manager 712 and relocation elements 710 and 717 of edge computing nodes 704 and 705. Once the edge manager has the necessary information to set up the secure tunnels, it creates the tunnel sessions for the relocation modules.

After successfully establishing secure tunnels from UE 702 to edge computing nodes 704 and 705, the next step is to migrate the application context data from source edge application 706 to target edge application 721 using UE 702 as an intermediary. For this purpose, edge manager 712 running on UE 702 initiates a context relocation request to relocation module 710 (735). Request 735 includes details about how to establish a connection to target relocation module 717 at edge computing node 705. This request can be transmitted via a secure channel, where both sides must authenticate and encrypt the communication using a method such as the mTLS protocol.

At this point, relocation module 710 will be responsible for gathering the application context data by sending message 736 to edge application 706. The application context is obtained with message 737. Pre-established tunnels 731 and 734 are then utilized to create a secure communication channel from relocation module 710 to relocation module 717. Over this secure tunnel, an end-to-end authentication and encryption protocol, such as mTLS, is employed in message 738 to transfer the application context data to destination edge computing node 705. The application context data is received at relocation module 717 and configured in edge application 721 with message 739. Once the application context data is configured in edge application 721, it responds to relocation module 717 with the result of the context update, as shown in message 740. Relocation module 717 will then transmit this notification message to source relocation module 710 via the secure channel using message 741.

Relocation module 710 of the edge computing node (704) uses message 742 to inform edge manager 712 that the application context relocation has been completed. Message 743 must include, among other information, the core network endpoint for accessing edge application 721. When client application 714 receives message 743, it changes the path from previous edge application 706 in edge computing node 704 to new edge application 721 available at edge computing node 705.

In the final stages of this sequence, edge manager 712 utilizes message 745 to initiate the cleanup procedure for the previous edge application. APP LCM 707 at edge computing node 704 triggers message 746 to remove the edge application and subsequently sends confirmation message 747 to edge manager 712, thus completing the cleanup process.

The present invention proposes a method for edge application configuration onboarding, edge application image uploading, edge application lifecycle management in edge computing nodes, and different methods to transfer application context data between edge computing nodes, all of which are directly controlled by UE devices. These devices usually have low computational power and limited energy supply. The method supports computational offloading, service delivery, and applications' migration in heterogeneous environments, where even connectivity between edge computing nodes may not be available. The steps of the proposed invention, which have already been explained according to the embodiments of the invention, are summarized below for a better understanding of the invention:

A UE device can connect to an edge data network with enough computational power for application offloading or service delivery (comprising edge computing nodes in the surrounding area). UE devices include multiple modules for managing the edge computing nodes as described in the previous embodiments. Specifically, three main modules:
a. Edge manager, in charge of orchestrating all the operations to control edge computing nodes.
b. Edge application repository, for storing and exposing the application images.
c. Edge context storage, for temporarily storing the application context data during migration procedures.

At the edge data network side, there exists a base station that provides wireless connectivity to the UE devices in the area. Alongside with this element, an edge computing node is also included. The edge computing node has four main modules:
a. Relocation module, to support application context data migration requirements. It transfers the application to the UE, receives context information to insert in executed applications, and establishes communication tunnels between edge computing nodes also using the UE device if it has simultaneous dual base station connectivity capabilities.
b. Onboarding module, to set up the configuration of application images, allowing them to be instantiated and executed on the edge computing node.
c. Edge application repository to store applications and expose them to other modules of the system.
d. Application lifecycle management, to manage all the lifecycle operations of the applications (e.g. instantiation, deletion, etc.).

The operation of the system starts when a UE device sets a connection to a new base station. At this point, the radio module on the UE will provide information about the edge capabilities of the node to the edge manager. Based on this information or any other, the radio module may trigger an application instantiation procedure. This procedure starts by performing a discovery of the application in the edge computing node. In case this procedure returns that the application is not available, the UE may start onboarding the application configuration in the edge computing node. Once the application onboarding is successful, the edge manager can request the destination edge application repository to pull the application image from the UE (application upload). After this procedure is finished, the edge manager can command the application instantiation in the edge computing node (application lifecycle management). Once the application is running on the edge computing node, the edge manager will receive a notification and will transfer it to the client application so that it can reconfigure the connection to the new application location.

At this point, the UE will have offloaded one of its applications to the edge computing node. However, as the UE moves around, it can lose base station signal or find other base stations more convenient from the point of view of radio performance. In these cases, the edge manager of the UE can trigger a relocation procedure. When no base stations are available in the area or the user equipment's radio cannot connect to multiple base stations simultaneously, the migration must be done in two stages. Firstly, the UE must gather and store the context data from the original edge computing node, or use a previous locally cached copy of the context. At this moment, it can also perform a cleanup procedure to stop the application running in the original edge computing node. Secondly, whenever the UE connects to a new base station with capabilities to execute the application, it can repeat the application onboarding, image uploading and application instantiation procedures on the edge computing node and, later, transfer the stored context data to that node. Finally, the edge manager will activate the client application to enable the communication with the edge application.

In some cases, the UE will have the capability to connect to multiple base stations simultaneously. If several base stations provide overlapping coverage, after the migration trigger, the UE may establish a connection with a new base station without disconnecting from the previous one. Meanwhile, the application will continue to run on the source edge computing node. The edge manager of the UE will initiate the application onboarding, image uploading and application instantiation procedures on the destination edge computing node. Subsequently, the edge manager will establish a communication link between the source and destination nodes, enabling direct communication not just for context transfer but also for other interoperability transfers. The source edge computing node will then directly transfer the application context data to the destination edge computing node through the established links. Upon completion of the context migration, the edge manager will activate the client application for communication. Finally, the application lifecycle management module will halt the application's operation on the source edge computing node as part of the cleanup procedure.

What is claimed is:

1. A method for decentralized management of edge computing nodes that are directly controlled by at least one user equipment device, the method comprising:
a. At each user equipment:
i. An edge manager module with
1. means for onboarding application configurations at edge computing nodes;
2. means for managing application lifecycles at edge computing nodes;
3. means for triggering the migration of edge applications and their context between edge computing nodes;
b. At each edge computing node:
i. An onboarding module with
1. means for receiving and storing application onboarding configurations sent by the edge manager modules of user equipment devices;
ii. A lifecycle manager module with:
1. means for the instantiation of edge applications, according to the onboarding configurations sent by the edge manager modules of user equipment devices;
2. means for updating edge applications, according to updating information sent by the edge manager modules of user equipment devices;
3. means for terminating edge applications as commanded by the edge manager modules of user equipment devices;
4. means for deleting edge applications as commanded by the edge manager modules of user equipment devices;
whereby said method allows user equipment devices to manage one or multiple edge computing systems with their edge manager modules, eliminating the need for a central management entity in the network.

2. The method of claim 1, where at each edge computing node there is a relocation module for edge application relocation operations between edge computing nodes as requested by the edge manager module.

3. The method of claim 2, where the relocation of an edge application between two edge computing nodes is made through the user equipment device, the user equipment device further including a context storage module and means for its edge manager module to request the context data of edge applications running in any edge computing node to the relocation modules of said edge computing node; temporarily storing these context data in the context storage module; onboarding a new edge application configurations in other edge computing nodes, instantiate the new edge applications, and add said context data to the new edge applications, whereby said method allows edge applications to be relocated without requiring integrating and directly interconnecting the edge nodes of the same or different owners.

4. The method of claim 3, where each edge computing node includes an edge application repository module to locally store edge application images.

5. The method of claim 3 where each terminal includes a terminal application repository module to locally store edge application images.

6. The method of claim 3 where each edge computing node includes an edge application repository module to locally store edge application images and each terminal includes a terminal application repository module to locally store edge application images.

7. The system of claim 3, where user equipment devices set direct concurrent radio connections with a plurality of edge computing nodes to exchange edge applications configurations, edge application contexts, application images or any other information.
